(19) United States
(12) Patent Application Publication
(10) Pub. No.: US 2025/0158308 A1
(43) Pub. Date: May 15, 2025

(54) ELECTRICAL TERMINALS

(71) Applicants: TE Connectivity Italia Distribution S.r.l., Collegno (IT); TE Connectivity Solutions GmbH, Schaffhausen (CN)

(72) Inventors: Fabio DE PASQUALE, Collegno (IT); Ugo AIME, Collegno (IT); Thomas KLENNER, Bensheim (DE); Clinton PEREIRA, Bangalore (IN)

(21) Appl. No.: 18/936,379

(22) Filed: Nov. 4, 2024

(30) Foreign Application Priority Data
Nov. 13, 2023 (IT) 102023000023955

(51) Int. Cl. H01R 13/115; H01R 11/12; H01R 13/03; H01R 13/11

(52) U.S. Cl. CPC H01R 13/115; H01R 11/12; H01R 13/03; H01R 13/113

(57) ABSTRACT

An electrical terminal for connecting a magnetic wire to a connector includes a flat wire contact portion for electrically connecting and hosting the magnetic wire, and a connector tab for the insertion into the connector, for example a RAST 2.5 connector. The connector tab is bended so as to include at least two parallel surfaces opposite to one another, separated by an empty space.

### CROSS REFERENCE TO RELATED APPLICATIONS

This application claims the benefit of IT Application No. 102023000023955, filed 13 Nov. 2023, the subject matter of which is herein incorporated by reference in its entirety.

### BACKGROUND OF THE INVENTION

The subject matter herein relates to electrical terminals, used in electrical appliances, for connecting magnetic wires to a connector.

In modern technologies, it is often necessary to use electrical terminals to connect magnetic wires, for example of a coil motor of an electrical appliance, for example a dishwasher, a washing machine or a dryer, to a connector, for example a RAST 2.5 connector. Such electrical terminals need, therefore, to be stable enough to guarantee a steady and reliable electrical connection also in environments subject to strong vibrations.

The electrical terminals known from the state of the art present several drawbacks. For example, in many cases, the physical characteristics of the material used to produce the electrical terminals and the method used to produce the same do not allow to form the region of the electrical terminal that needs to be inserted into the connector, in such a way that both the integrity and durability of the electrical terminal and, at the same time, a stable connection with the connector are guaranteed. This is related mainly to the thickness and the physical characteristics of the material used to produce the electrical terminals.

More in particular, on the one hand a more elaborated design of the electrical terminal can increase the contact area between the terminal and the connector, but it also can increase the possibility for the electrical terminal to produce crack or orange peeling during its production or use. On the other hand, a too simple design of the electrical terminal could assure its integrity and durability but it could also not provide an enough extended contact area with the connector. This could bring to a too easy disconnectability of the electrical terminal from the connector, especially in an environment subject to high vibrations.

In view of the above, it would be advantageous to find a solution that would provide an electrical terminal with a design that assures both the integrity and durability of the electrical terminal and its stable connection to a connector.

### BRIEF DESCRIPTION OF THE INVENTION

In an embodiment, an electrical terminal for connecting a magnetic wire to a connector s provided including a flat wire contact portion for electrically connecting and hosting the magnetic wire, and a connector tab for the insertion into the connector, for example a RAST 2.5 connector; wherein the electrical terminal is such that the connector tab is bended so as to comprise at least two parallel surfaces opposite to one another, separated by an empty space.

The used design increases the electrical terminal performance, because it assures at the same time the durability and stability of the electric terminal and a large contact area with the connector. Moreover, when the electrical terminal is inserted inside the connector, each of its parallel surfaces is in electrical contact with the electrical springs of the connector and being the parallel surfaces separated by an empty space, they are placed at a distance from each other, so that they steadily remain inside the connector, also when the system is subject to strong vibration, for example during the operation of the appliance device.

In the ambit of the present disclosure, it is considered that the electrical terminal defines a XYZ orthogonal coordinate system as follows: the flat wire contact portion defines the YZ plane, wherein Z is the direction parallel to the connector tab and the X direction is the direction perpendicular to the YZ plane.

In the ambit of the present disclosure, magnetic wires are conductive wires covered by a covering insulating material. An example of a suitable conductive material is copper. Examples of suitable covering insulating materials are polymer film materials, such as polyvinyl formal (Formvar), polyurethane, polyamide, polyester, polyester-polyimide, polyamide-polyimide (or amide-imide), and polyimide. Magnetic wires are typically employed for applications that require tight coils of insulated wire. The magnetic wires to be connected to the electrical terminal can have different thickness, for example 0.236 mm or less. The magnetic wires can be those of a coil motor of an appliance device, for example a dishwasher, a washing machine or a dryer.

A RAST connector is a kind of connector known to the skilled person. For example, a description of RAST connectors can be found in the prior art document D1: ‘RAST CONNECTOR SYSTEM—IDC & CRIMP CONNECTOR SYSTEM AND RAST TAB HEADER’, February 2016, downloadable from the following link: https://www.te.com/commerce/DocumentDelivery/DDEController?Action=srchrtrv&Doc Nm=1-1773727-3_RAST_Connector_System&DocType=CS&DocLang=EN

The teaching of D1 with respect to RAST connectors is herewith incorporated by reference in its entirety. In particular, all the structural and functional properties of the RAST connectors described in document D1 are herewith incorporated by reference. All the possible dimensions and functionalities of the RAST connectors described in document D1 are herewith incorporated by reference. The method of operating the connectors can also be adopted according to embodiments of the subject matter herein and is herewith incorporated by reference in its entirety.

In particular, RAST 2.5 connectors are known to the skilled person. In particular, all the structural and functional properties of the RAST 2.5 connectors described on pages 120 to 131 of document D1 are herewith incorporated by reference. All the possible dimensions and functionalities of the RAST 2.5 connectors described on pages 120 to 131 of document D1 are herewith incorporated by reference. The method of operating the connectors can also be adopted according to embodiments of the subject matter herein and is herewith incorporated by reference in its entirety. For example, a RAST 2.5 connector can have three terminal seats, separated of 2.5 mm form each other, each with a dimension of 1.6 mm along the Y direction and a dimension of 1.5 mm along the X direction. Inside each seat there are two conductive springs, as shown, for example, in document D1, pages 13, 34 and 51, that assure the electrical connection of the RAST connector to the electrical terminals. The dimensions of 1.5 mm along the X direction of the terminal seat, in the RAST 2.5 connector, allow the proper deformation of the springs inside each seat, once the corresponding terminal is connected.

Preferably, the terminal according to the subject matter herein comprises only one single flat wire contact portion.

According to an embodiment of the subject matter herein, the electrical terminal is made of a CuNiSi (copper, nickel and silicon) alloy. Several technical studies and experiments, implemented by the inventors of the present invention, showed that such a material has the appropriate physical properties, for example, the r/t (r is the bending radius and t the thickness of the electrical terminal) ratio, to be bended so as to form an electrical terminal according to the subject matter herein. More in particular, while bending the connector tab of the electrical terminal according to this embodiment, no cracks or orange peeling are produced during the manufactory process. This is advantageous to guarantee the stability and durability of the electrical connector. Cracks or the presence of orange peeling can, in fact, result into the break of the electrical terminal under stress conditions.

According to an embodiment of the subject matter herein, the electrical terminal has a thickness less than or equal to 0.5 mm. Several technical studies and experiments, implemented by the inventors of the present invention, showed that such thickness values are optimal to form an electrical terminal according to the subject matter herein. More in particular, while bending the connector tab of the electrical terminal, no cracks or orange peeling are produced during the manufactory process. This is advantageous to guarantee the stability and durability of the electrical connector. Cracks or the presence of orange peeling can, in fact, result into the break of the electrical terminal under stress conditions. An electrical terminal with such a thickness is, for example, suitable to connect magnetic wires with a thickness of 0.236 mm.

According to a further embodiment of the subject matter herein, the wire contact portion has a higher thickness with respect to the connector tab, for example the thickness of the wire contact portion is equal to 0.5 mm and the thickness of the connector tab is less than 0.5 mm, for example 0.32 mm. To further increase the malleability of the electrical terminal, it is also possible to give to the wire contact portion and to the connector tab two different thicknesses. More in particular, the thickness of the contact portion can be 0.5 mm and the thickness of the connector tab can be reduced, by using, for example, a milling process, to a value of 0.32 mm or less. In this way, the bending process can be further facilitated.

According to an embodiment of the subject matter herein, the width of the two parallel surfaces, along the Y axis, is less than or equal to 1.6 mm. The connector into which the connector tab of the electrical terminal has to be inserted, comprises terminal seats to host the connector tab of the electrical connector. Each terminal seat of the connector comprises two parallel conductive springs, as shown in document D1, pages, 13, 34 or 51, that are, respectively, put in contact with the two parallel surfaces of the electrical terminal, when the connector tab is inserted inside the connector, for example a RAST 2.5 connector as the one described in document D1, pages 120 to 131. The connector tab is, in fact, inserted inside the connector, so that the two parallel surfaces result to be parallel to the two parallel conductive springs in each seat. The dimensions of 1.5 mm along the X direction of the terminal seats, in the RAST 2.5 connector, allows the proper deformation of the springs inside each seat, once the corresponding terminal is connected.

According to an embodiment of the subject matter herein, the distance of the two parallel surfaces, along the X axis, is at least 0.5 mm. The connector into which the connector tab of the electrical terminal has to be inserted, comprises terminal seats to host the connector tab of the electrical connector. Each terminal seat of the connector comprises two parallel conductive springs, as shown, for example in document D1, pages 13, 34 or 51, that are, respectively, put in contact with the two parallel surfaces of the electrical terminal, when the connector tab is inserted inside the connector, for example a RAST 2.5 connector as the one described in document D1, pages 120 to 131. The connector tab is inserted inside the connector, so that the two parallel surfaces results to be parallel to the two parallel conductive springs in each seat. Since the distance of the two parallel surfaces is at least 0.5 mm, and each parallel surface has a thickness less than or equal to 0.5 mm, the thickness of the connector tab is 1.5 mm. This thickness can be left unvaried, also when the thickness of each parallel surface is decreased, by increasing the distance of the same. An electrical terminal with a connector tab with such a thickness does not easily move inside it terminal seat. For this reason, the stability of the connection is guaranteed.

According to an embodiment of the subject matter herein, at least one of the parallel surfaces comprises a stopper, extending into the empty space, so as to prevent the two parallel surfaces from coming into contact, when they are subject to a compressive force that tends to bring them closer to each other. During the insertion procedures of the connector tab into a terminal seat, when the two parallel surfaces are subject to a force that tend to move them nearer to each other, the stopper assures that the two parallel surfaces remain at a minimum mutual distance to each other, for example at a minimum mutual distance of at least 0.5 mm. The contact area between the connector tab and the connector cannot accidentally decrease, even when the system is subject to strong vibrations.

According to an embodiment of the subject matter herein, the stopper is a protrusion, for example a hook, extending into the empty space. For example, the stopper can be shaped into a hook, but any other suitable form falls into the protection field of the subject matter herein. The protrusion can be formed, for example, on the free end of the connector tab, preferably at its center, or in any other convenient place onto the two parallel surfaces. This specific position of the stopper results particularly convenient to avoid the unwanted approach of the two parallel surfaces.

According to an embodiment of the subject matter herein, the parallel surfaces of the connector tab are obtained by bending the connector tab once by 180° around a 180°-bending-axis parallel to the Y axis. In this way, a 180°-bended electrical terminal is obtained. First the electrical terminals are cut, from a band of metallic material extending in the Y direction, in a cutting station of a production machine, so as to comprise a connector tab that extends on the YZ plane along the Z direction. The electrical terminals are arranged one next to the other on the metallic band, so that they are still united in correspondence of their bard structures. Later, in at least a bending station of the production machine, the connector tab of each electrical terminal is bended of 180° around a 180°-bending-axis Y1parallel to the Y axis. The bending process can be performed in a single step, in a single bending station or in two or more steps into two or more different bending stations. This way of bending the metallic material, parallel to the direction Y of extension the metallic band, is called: good way. Finally the band containing the electrical terminals is wrapped around a transporting coil, to be transported. This process allow to maintain a low pitch between two adjacent electrical connectors, with the result lowering the production costs with respect to the electrical terminal known from the state of the art.

According to an embodiment of the subject matter herein, the 180°-bending-axis cuts the connector tab into two equally long halves, each of which forms one of the parallel surfaces. In this way the two parallel surface have the same length along the Z direction. However, the 180°-bending axis can cut the connector tab in any suitable point, so as to obtain any desired ratio between the lengths of the two parallel surfaces.

According to an embodiment of the subject matter herein, the parallel surfaces are obtained by bending the connector tab a first time by 90° around a first-90°-bending-axis and a second time around a second-90°-bending-axis parallel to each other and to the Z axis, the first-90°-bending-axis and the second-90°-bending-axis having a mutual distance along the X axis, for example a mutual distance less than or equal to 0.6 mm along the X axis. The electrical terminals T are first cut, for a metallic band, in a cutting station of a production machine so as to comprise a connector tab that extends on the YZ plane along the Z direction and having a dimension along the Y axis equal to the sum of the width of the two parallel surfaces plus the perpendicular surface. The electrical terminals are arranged one next to the other on the metallic band, so that they are still united in correspondence of their bard structures. Later, in a first bending station of the production machine, the connector tabs are bended of 90° around a first 90°-bending-axis Z1 parallel to the Z axis. Therefore, in a second bending station of the production machine, the connector tabs are bended again of 90° around a second 90°-bending-axis Z2, parallel to the Z axis and distant from the first 90°-bending-axis Z1 at least 0.5 mm along the X direction. The dimensions of the empty space between the two parallel surfaces, is therefore related to the mutual distance between the first-90°-bending axis and of the second 90°-bending axis. This way of bending the metallic material, perpendicular to the direction Y of extension the metallic band, is called: bad way. The realization of this embodiment require, therefore, at least two bending steps.

According to an embodiment of the subject matter herein, the wire contact portion comprises a fork structure comprising two prongs forming a IDC slit suitable to host the magnetic wire. The fork structure facilitates the insertion of the magnetic wire into the electrical connector. Such a design is suitable, for example, for magnetic wires having a thickness of 0.236 mm. The dimensions and the shape of the wire contact portion can be changed according to the needs, for example magnetic wires with different thicknesses. A contact portion of an electrical terminal having such a shape can be found, for example, in SIAMEZE terminals.

According to an embodiment of the subject matter herein, the IDC slit comprises a V shape, so as to facilitate the insertion of the magnetic wire. Such a shape is particularly convenient because the insertion of the magnetic wire into the electrical terminal results simple.

According to an embodiment of the subject matter herein, the IDC slit comprises stripping burrs so as to peel the cover insulating layer of the magnetic wire. The stripping burrs provide for the peeling of the cover insulating layer of the magnetic wire. In this way, the exposed conductive layer can be in electrical contact with the electrical terminal.

According to an embodiment of the subject matter herein, the two prongs, each comprises a punch hole, so as to make said prongs more elastic and therefore facilitating the termination procedure of the magnetic wire. Such a design is advantageous to facilitate the termination of the magnetic wire, into the electrical terminal, without damaging it

The subject matter herein further concerns a connecting system comprising one or more electrical terminals according to any of the embodiments described above and a connector, for example, a RAST 2.5 connector.

A RAST connector is a kind of connector known to the skilled person.

For example, a description of RAST connectors can be found in the prior art document D1: ‘RAST CONNECTOR SYSTEM—IDC & CRIMP CONNECTOR SYSTEM AND RAST TAB HEADER’, February 2016, downloadable from the following link: https://www.te.com/commerce/DocumentDelivery/DDEController?Action=srchrtrv&Doc Nm=1-1773727-3_RAST_Connector_System&DocType=CS&DocLang=EN

The teaching of D1 with respect to RAST connectors is herewith incorporated by reference in its entirety. In particular, all the structural and functional properties of the RAST connectors described in document D1 are herewith incorporated by reference. All the possible dimensions and functionalities of the RAST connector described in document D1 are herewith incorporated by reference. The method of operating the connectors can also be adopted according to embodiments of the subject matter herein and is herewith incorporated by reference in its entirety.

In particular, RAST 2.5 connectors are known to the skilled person. In particular, all the structural and functional properties of the RAST 2.5 connectors described on pages 120 to 131 of document D1 are herewith incorporated by reference. All the possible dimensions and functionalities of the RAST 2.5 connectors described on pages 120 to 131 of document D1 are herewith incorporated by reference. The method of operating the connectors can also be adopted according to embodiments of the subject matter herein and is herewith incorporated by reference in its entirety.

The subject matter herein further concerns a connecting assembly comprising a connecting system according to the subject matter herein and one or more magnetic wires, each inserted inside one electrical terminal according to the subject matter herein. The magnetic wires can be, for example, the coils of a coil motor, for example the motor of an appliance device, such as a dishwasher, a washing machine or a dryer.

The subject matter herein further concerns an electrical appliance, for example a dishwasher, a washing machine or a dryer, comprising one or more connecting assemblies according to the subject matter herein. The connecting assembly according to the subject matter herein comprising electrical terminals, according to the subject matter herein, providing the electrical connection between the magnetic wires of a coil motor and a connector, for example a RAST 2.5 connector, assures a stable connection also in high vibration environments, such as in the case of electrical appliances.

### BRIEF DESCRIPTION OF THE DRAWINGS

The present invention will be described with reference to the attached figures, in which the same reference numerals and/or signs indicate the same part and/or similar and/or corresponding parts of the machine.

FIG. 1A shows a 3D view of an electrical terminal according to an embodiment of the subject matter herein with a 180°-bended connector tab;

FIG. 1B shows a lateral view of the electrical terminal shown in FIG. 1A;

FIG. 2A shows a 3D view of an electrical terminal according to an embodiment of the subject matter herein with a double-90°-bended connector tab;

FIG. 2B shows a lateral view of the electrical terminal shown in FIG. 2A;

FIG. 3 shows a 3D view of a connecting system comprising three electrical terminals according to the subject matter herein, inserted inside a connector;

FIG. 4A shows a 3D exploded view of the connecting assembly comprising the connecting system shown in FIG. 3, a connector cover and 3 magnetic wires inserted in a conveying ramp RM, ready to be connected to the electric terminals according to the subject matter herein;

FIG. 4B shown a 3D view of the connecting assembly shown in FIG. 4A, in the assembled state.

### DETAILED DESCRIPTION OF THE INVENTION

In the following, the present invention is described with reference to particular embodiments, as shown in the enclosed drawings. Nevertheless, the present invention is not limited to the particular embodiments described in the following detailed description and shown in the figures, instead, the embodiments described simply exemplify several aspects of the present invention, the scope of which is defined by the appended claims.

Further modifications and variations of the present invention will be clear for the person skilled in the art. Therefore, the present description has to be considered as including all the modifications and/or variations of the present invention, the scope of which is defined by the appended claims.

For simplicity, identical or corresponding components are indicated in the figures with the same reference numbers.

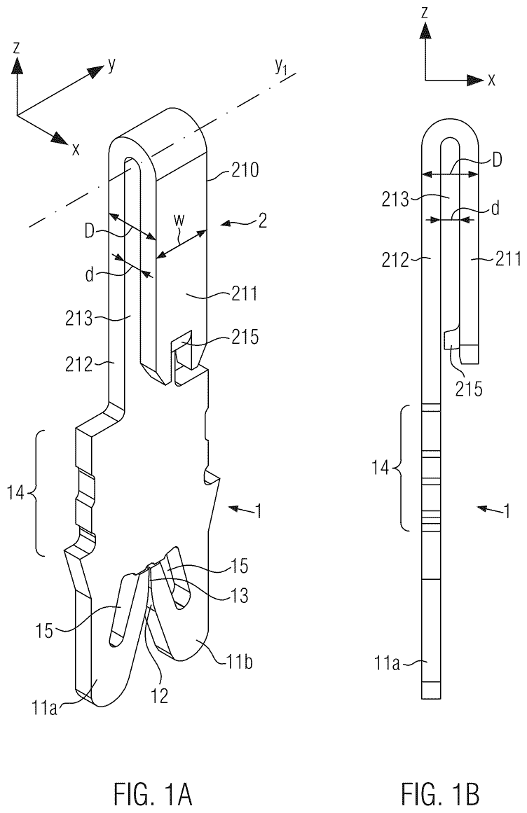

FIG. 1A shows a 3D view of an electrical terminal T according to an embodiment of the subject matter herein with a 180°-bended connector tab 210.

The electrical terminal T shown in FIG. 1A is an electrical terminal T for connecting a magnetic wire MW to a connector C. The electrical terminal T comprises a flat wire contact portion 1 for electrically connecting and hosting the magnetic wire MW, and a connector tab 2 for the insertion into a connector C, for example a RAST 2.5 connector.

The electrical terminal T defines a XYZ orthogonal coordinate system, wherein the flat wire contact portion 1 defines the YZ plane. The Z is the direction parallel to the connector tab 2 and the X direction is the direction perpendicular to the YZ plane.

The electrical terminal T can be made of a CuNiSi (copper, nickel and silicon) alloy. This material allows the electrical terminal T to be formed with a bended connector tab 2, as will be better explained in what follows, without compromising the stability and the integrity of the electrical terminal T.

According to the embodiment shown in FIG. 1A, the electrical terminal T has a thickness of 0.5 mm. The thickness of electrical terminal T is the same both for the flat wire contact portion 1 and for the for the connector tab 2. However, this is not the only possibility and in order to make the bending process easier to perform, the thickness of the connector tab 2 can also be less that 0.5 mm, for example 0.324 mm. This makes the bending procedures safer, so as not to damage the connector tab 2.

The wire contact portion 1 comprises a fork structure 11 comprising two prongs 11a, 11b. The two prongs 11a, 11b define an insulation displacement connector slit 12, IDC slit 12 in what follows, that is suitable to electrically connect and host the magnetic wire MW. The IDC slit 12 forms, in fact, a V profile that facilitate the insertion of the magnetic wire MW.

Moreover, the IDC slit 12 comprises stripping burrs 13 that peel the covering insulating layer IL of the magnetic wire MW. In this way, when the magnetic wire MW is completely inserted into the IDC slit 12, the conductive layer CL of the magnetic wire MW is in electrical contact with the electrical terminal T and is hold in place into the tightest part of the IDC slit 12.

According to the embodiment shown in FIG. 1A, the two prongs 11a, 11b, each comprises a punch hole 15. This punch holes 15 allow the prongs 11a, 11b to have a more elastic structure, so as to facilitate the insertion of the magnetic wire MW into the IDC slit 12. The form of the shown punch holes 15 is elliptical, but any other suitable form falls into the field of protection of this patent application.

The wire contact portion 1 further comprises lateral barb structures 14. The barb structures 14 have a profile determined according to the requirements of the cutting process (not shown in the figures). The electrical terminals are, in fact, formed on a band of the metallic material, one next to the other along the Y axis. The electrical terminals T are not separated one from the other before their use, but they are encased onto a transport coil. The barb structures 14, for example, can facilitate the encasement of electrical terminals T onto the transport coil.

The electrical terminal T further comprises a connector tab 2 suitable to be inserted into a connector C.

In the embodiment shown in FIG. 1A the connector tab 2 is a 180°-bended connector tab 210. The 180°-bended connector tab 210 comprises two parallel surfaces 211, 212 opposite to one another, separated by an empty space 213. The parallel surfaces 211, 212 of the connector tab 210 are obtained by bending the connector tab 210 once by 180° around a 180°-bending-axis Y1 parallel to the Y axis.

The width W of the parallel surfaces 211, 212 along the Y axis, is less than or equal to 1.6 mm. The distance d of the two parallel surfaces 211, 212 along the X axis is at least 0.5 mm. It results that, since the thickness of the electrical terminal is 0.5 mm, the thickness D of the connector tab 210 along the X direction is 1.5 mm. In the case in which the thickness of the connector tab 210 is less that 0.5 mm, for example 0.4 mm, the distance d of the two parallel surfaces 211, 212 along the X axis is larger, for example 0.6 mm, so that the thickness D of the connector tab 210 along the X direction remains of 1.5 mm. The dimensions of the connector tab 210 both along the X and the Y directions, assure a stable connection, with a large contact area, between the electrical terminal T and the connector C.

The electrical terminal T is first cut in a cutting station of a production machine, not shown in the figures, so as to comprise a connector tab 210 that extends on the YZ plane along the Z direction. Later, in at least a bending station of the production machine, also not shown in the figures, the connector tab 210 is bended of 180° around a 180°-bending-axis Y1 parallel to the Y axis. The bending process can be performed in a single step, in a single bending station or in two or more steps into two or more different bending stations. This process allow to bend the material strip without any cracks or orange peeling on the tab surface, creating the tab interface and assuring the functionality of the terminal.

According to the embodiment shown in FIG. 1A one of the two parallel surfaces 211, 212 comprises a stopper 215, extending into the empty space 213, suitable to assure the electrical connection of the electrical terminal T with the connector C, even when the two parallel surfaces 211, 212 are subject to a compressive force that tends to bring them closer to each other. This is the case, when the connector tab 210 is inserted inside the connector C, for example, a RAST 2.5 connector R. The stopper 214, blocks the two parallel surfaces 211, 212 from come in contact to each other, so that the width D of the connector tab 210 does not shrink and a proper contact with the connector C is assured. In the embodiment shown in the figure, the stopper 215 protrudes from the free end, at its center, of parallel surface 211. This specific position of the stopper 215 results particularly convenient to avoid the unwanted approach of the two parallel surfaces 211, 212.

The described bending processes are advantageously rendered more efficient because the CuNiSi alloy used to produce the electrical terminal T has a r/t (r is the bending radius and t the thickness of the electrical terminal) ratio that allows the bending of the connector tab 210 of the electrical terminal T, without producing crack or orange peeling during the manufactory process. The durability and integrity of the electrical terminal T is, therefore, guaranteed. Cracks or the presence of orange peeling can, in fact, result into the break of the electrical terminal under stress conditions.

FIG. 1B shows a lateral view of the electrical terminal shown in FIG. 1A. This figure shows more clearly the structure of the connector tab 210, more in particular, the two parallel surfaces 211 and 212.

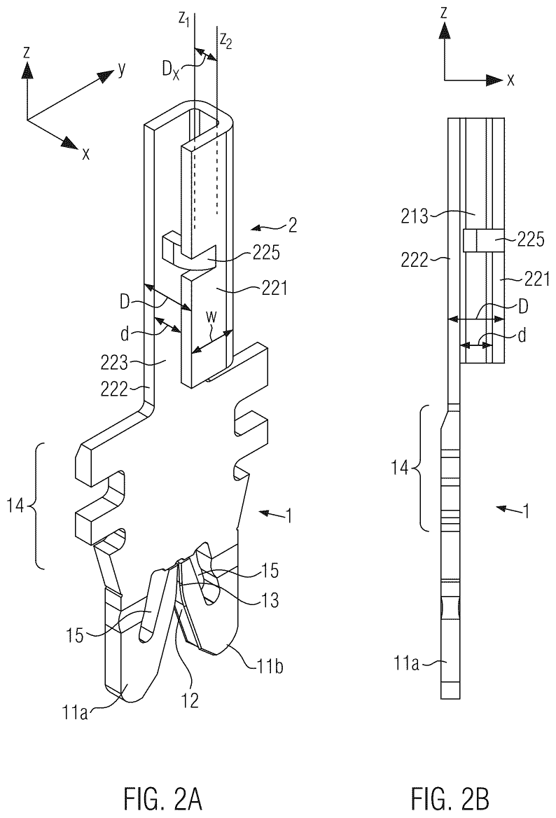

FIG. 2A shows a 3D view of an electrical terminal T according to an embodiment of the subject matter herein with a double-90°-bended connector tab 220.

The electrical terminal T shown in FIG. 2A is an electrical terminal T for connecting a magnetic wire MW to a connector C. The electrical terminal T comprises a flat wire contact portion 1 for electrically connecting and hosting the magnetic wire MW, and a connector tab 2 for the insertion into said connector C, for example a RAST 2.5 connector R.

The flat wire contact portion 1 of the electrical terminal shown in FIG. 2A has the same characteristics of the one of the electrical terminal T shown in FIG. 1A. These characteristics can be changed according to needs, for example magnetic wires MW with different thickness.

The electrical terminal T further comprises a connector tab 2 suitable to be inserted into a connector C.

In the embodiment shown in FIG. 2A the connector tab 2 is a double-90°-bended connector tab 220. The double-90°-bended connector tab 220 comprises two parallel surfaces 221, 222 opposite to one another, separated by an empty space 223. The parallel surfaces 221, 222 of the connector tab 220 are obtained by bending the connector tab 220 a first time by 90° around a first-90°-bending-axis Z1 and a second time around a second-90°-bending-axis Z2 parallel to the Z axis. The first-90°-bending-axis Z1 and the second-90°-bending-axis Z2 have a distance Dx less than or equal to 0.86 mm along the X axis. Due to this bending process, the final double-90°-bended connector tab 220 comprises two parallel surfaces 221, 222 and a perpendicular surface 224, that bridges the two parallel surfaces 221, 222.

The width W of the parallel surfaces 221, 222 along the Y axis, is less than or equal to 1.6 mm. The distance d of the two parallel surfaces 221, 222 along the X axis, is at least 0.5 mm. It results that, since the thickness of the electrical terminal is 0.5 mm, the thickness D of the connector tab 220 along the X direction is 1.5 mm. In the case in which the thickness of the connector tab 220 is less that 0.5 mm, for example 0.4 mm, the distance d of the two parallel surfaces 221, 222 along the X axis is larger, for example 0.7 mm, so that the thickness D of the connector tab 220 along the X direction remains of 1.5 mm. The dimensions of the connector tab 220 both along the X and the Y directions, assure a stable connection, with a large contact area, between the electrical terminal T and the connector C.

The electrical terminal T is first cut in a cutting station of a production machine, not shown in the figures, so as to comprise a connector tab 220 that extends on the YZ plane along the Z direction and having a dimension along the Y axis equal to the sum of the width of the two parallel surfaces 221, 222 plus the perpendicular surface 224. Later, in a first bending station of the production machine, not shown in the figures, the connector tab 220 is bended of 90° around a first 90°-bending-axis Z1 parallel to the Z axis. Therefore, in a second bending station of the production machine, not shown in the figures, the connector tab 220 is bended again of 90° around a second 90°-bending-axis Z2, parallel to the Z axis and distant from the first 90°-bending-axis Z1 at least 0.5 mm along the X direction. The realization of this embodiment require, therefore, at least two bending steps.

According to the embodiment shown in FIG. 2A one of the two parallel surfaces 221, 222 comprises a stopper 225, extending into the empty space 223, suitable to assure the electrical connection of the electrical terminal T with the connector C, even when the two parallel surfaces 221, 222 are subject to a compressive force that tends to bring them closer to each other. This is the case, when the connector tab 220 is inserted inside the connector C, for example, a RAST 2.5 connector R. The stopper 225, blocks the two parallel surfaces 221, 222 from come in contact to each other, so that the width D of the connector tab 220 does not shrink and a proper contact with the connector C is assured. In the embodiment shown in the figure, the stopper 225 protrudes from the free end, at its center, of parallel surface 221. This specific position of the stopper 225 results particularly convenient to avoid the unwanted approach of the two parallel surfaces 221, 222.

The described bending processes are advantageously rendered more efficient because the CuNiSi alloy used to produce the electrical terminal T has a r/t (r is the bending radius and t the thickness of the electrical terminal) ratio that allow the bending of the connector tab 210 of the electrical terminal T, without producing crack or orange peeling during the manufactory process. The durability and integrity of the electrical terminal T is, therefore, guaranteed.

FIG. 2B shows a lateral view of the electrical terminal shown in FIG. 2A. This figure shows more clearly the structure of the connector tab 220. More in particular, it shows the two parallel surfaces 221 and 222 and the perpendicular surface 224.

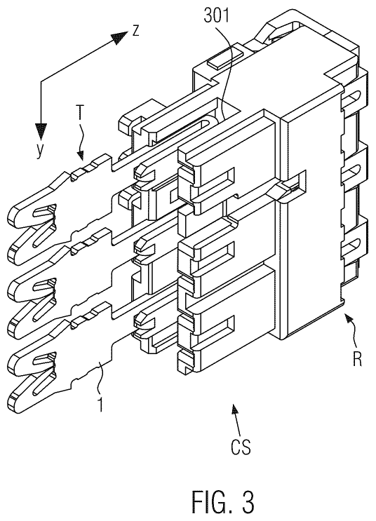

FIG. 3 shows a 3D view of a connecting system CS comprising three electrical terminals T according to the subject matter herein, inserted inside a connector C.

The three electrical terminals T shown in FIG. 3 are the ones comprising a 180°-bended connector tab 210, according to the subject matter herein.

The connector C is a RAST 2.5 connector R. The RAST 2.5 connector R shown in FIG. 3, comprises three terminal seats 301, spaced 2.5 mm from each other.

Each terminal seat 301 comprises two parallel conductive springs 302 that are, respectively put in contact with the two parallel surfaces 211, 212, 221, 222 of the electrical terminal T, when the connector tab 210, 220 is inserted inside the RAST 2.5 connector R. The connector tab 210, 220 is, in fact, inserted inside the RAST 2.5 connector R, so that the two parallel surfaces 211, 212, 221, 222 results to be parallel to the two parallel conductive springs 302. The dimensions of 1.5 mm along the X direction of the terminal seats 301 allows the proper deformation of the springs 302 inside each seat 301, once the corresponding terminal T is connected.

The electrical terminal T according to the subject matter herein, has, therefore, the proper dimensions to fit in it. The dimensions of the electrical terminals T according to the subject matter herein, can be varied according to the dimensions of the seats of the connector into which they need to be inserted.

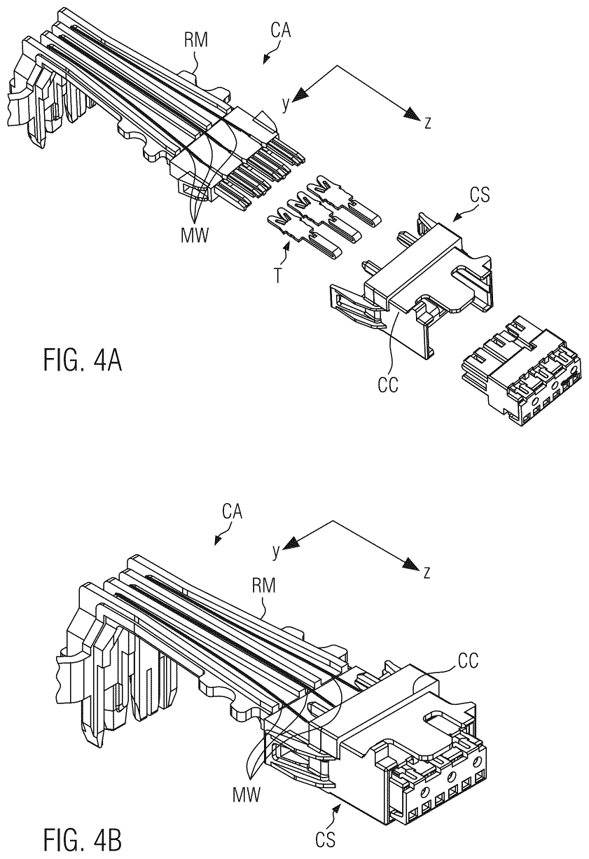

FIG. 4A shows a 3D exploded view of the connecting assembly CA comprising the connecting system CS shown in FIG. 3, a connector cover CC and three magnetic wires inserted in a conveying ramp RM, ready to be connected to the electric terminals T according to the subject matter herein.

According to the embodiment shown if FIG. 4A, three magnetic wires MW coming from a motor (not shown in the figures) of an electrical appliance, for example a dishwasher, need to be electrical connected to a RAST 2.5 connector R. The magnetic wires according to the embodiment shown have, for example, a thickness of 0.236 mm. The three magnetic wires MW are each inserted inside a guide of a conveying ramp RM. The conveying ramp RM, collects the magnetic wires MW and hold them in position so that they can be connected to three electrical terminals T according to the subject matter herein.

A connector cover CC fixes the connection of the three electrical terminals T according to the subject matter herein, with the RAST 2.5 connector R and the magnetic wires MW.

FIG. 4B shown a 3D view of the connecting assembly CA shown in FIG. 4A in the assembled state.

In FIG. 4B the three electrical terminals T are each connected to the three magnetic wires MW. More in particular, each magnetic wire MW is inserted into the corresponding IDC slit 12 of the flat wire contact portion 1 of the corresponding electrical terminal T. The stripping burrs 13 have cut the insulating layer IL of the magnetic wire MW and the conductive layer CL is in electrical contact with the electrical terminal T.

Further, the connector tabs 2 of each electrical terminal T are inserted into the corresponding terminal seat 301 of the RAST 2.5 connector R.

Finally, the connector cover CC closes the system so to fix the connection of the three electrical terminals T according to the subject matter herein, with the RAST 2.5 connector R and the magnetic wires MW of the coil motor of the appliance device.

Further modifications and variations of the present invention will be clear for the person skilled in the art. Therefore, the present description has to be considered as including all the modifications and/or variations of the present invention, the scope of which is defined by the appended claims.

Even though the present invention has been described with reference to the embodiments described above, it is clear to those skilled in the art that it is possible to make different modifications of the present invention in light of the teaching described above and in the appended claims, without departing from the scope of protection of the invention.

For example, the shape of the flat wire contact portion 1 can be modified with respect to the one shown on the figures, so as to adapt to the specific necessity of the system in which they need to be used, for example, in the case of magnetic wires with different size.

Moreover, the number of terminal seats of the connector can be in a different number and can have different dimensions. The dimensions and number of the electrical terminals can accordingly vary.

Finally, those aspects that are considered known by those skilled in the art have not been described in order to avoid excessively obscuring the description of the invention. Consequently, the invention is not limited to the embodiments described above, but is only limited by the scope of protection of the appended claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical terminal for connecting a magnetic wire to a connector, the electrical terminal comprising:
a flat wire contact portion for electrically connecting and hosting said magnetic wire; and
a connector tab for the insertion into said connector;
wherein said electrical terminal defines a XYZ orthogonal coordinate system, wherein said flat wire contact portion defines the YZ plane, wherein Z is the direction parallel to the connector tab and the X direction is the direction perpendicular to the YZ plane;
wherein said connector tab is bended to include at least two parallel surfaces opposite to one another, separated by an empty space.

2. Electrical terminal according to claim 1, wherein said terminal is made of a CuNiSi (copper, nickel and silicon) alloy.

3. Electrical terminal according to claim 1, wherein said terminal has a thickness less than or equal to 0.5 mm.

4. Electrical terminal according to claim 1, wherein said wire contact portion has a higher thickness with respect to said connector tab

5. Electrical terminal according to claim 4, wherein the thickness of said wire contact portion is equal to 0.5 mm and the thickness of said connector tab is less than 0.5 mm.

6. Electrical terminal according to claim 1, wherein the width of said two parallel surfaces, along the Y axis, is less than or equal to 1.6 mm.

7. Electrical terminal according to claim 1, wherein the distance of said two parallel surfaces, along the X axis, is at least 0.5 mm.

8. Electrical terminal according to claim 1, wherein at least one of said parallel surfaces comprises a stopper, extending into said empty space so as to prevent said two parallel surfaces from coming into contact, when they are subject to a compressive force that tends to bring them closer to each other.

9. Electrical terminal according to claim 8, wherein said stopper is a protrusion extending into said empty space.

10. Electrical terminal according to claim 8, wherein said stopper is a hook extending into said empty space.

11. Electrical terminal according to claim 1, wherein said parallel surfaces are obtained by bending said connector tab once by 180° around a 180°-bending-axis parallel to said Y axis.

12. Electrical terminal according to claim 11, wherein said 180°-bending-axis cuts the connector tab into two equally long halves, each of which forms one of said parallel surfaces.

13. Electrical terminal according to claim 1, wherein said parallel surfaces are obtained by bending said connector tab a first time by 90° around a first 90°-bending-axis and a second time around a second 90°-bending-axis parallel to each other and to the Z axis, said first-90°-bending-axis and said second-90°-bending-axis having a mutual distance along the X axis.

14. A connecting system comprising:
one or more electrical terminals, each electrical terminal including a flat wire contact portion for electrically connecting and hosting said magnetic wire and a connector tab, wherein said electrical terminal defines a XYZ orthogonal coordinate system, wherein said flat wire contact portion defines the YZ plane, wherein Z is the direction parallel to the connector tab and the X direction is the direction perpendicular to the YZ plane, and wherein said connector tab is bended to include at least two parallel surfaces opposite to one another, separated by an empty space; and
a connector holding the connector tab of the one or more electrical terminals.

15. Connecting system according to claim 14, wherein said terminal has a thickness less than or equal to 0.5 mm, said wire contact portion having a higher thickness with respect to said connector tab.

16. Connecting system according to claim 14, wherein the width of said two parallel surfaces, along the Y axis, is less than or equal to 1.6 mm, and wherein the distance of said two parallel surfaces, along the X axis, is at least 0.5 mm.

17. Connecting system according to claim 14, wherein at least one of said parallel surfaces comprises a stopper, extending into said empty space so as to prevent said two parallel surfaces from coming into contact, when they are subject to a compressive force that tends to bring them closer to each other.

18. A connecting assembly comprising:
a connecting system including a connector and one or more electrical terminals held in the connector, each electrical terminal including a flat wire contact portion and a connector tab for insertion into said connector, wherein said electrical terminal defines a XYZ orthogonal coordinate system, wherein said flat wire contact portion defines the YZ plane, wherein Z is the direction parallel to the connector tab and the X direction is the direction perpendicular to the YZ plane, and wherein said connector tab is bended to include at least two parallel surfaces opposite to one another, separated by an empty space; and
one or more magnetic wires each inserted inside one of said electrical terminals.

19. Connecting assembly according to claim 18, wherein said terminal has a thickness less than or equal to 0.5 mm, said wire contact portion having a higher thickness with respect to said connector tab.

20. Connecting assembly according to claim 18, wherein at least one of said parallel surfaces comprises a stopper, extending into said empty space so as to prevent said two parallel surfaces from coming into contact, when they are subject to a compressive force that tends to bring them closer to each other.
